(19) United States
(12) Patent Application Publication
(10) Pub. No.: US 2004/0243513 A1
(43) Pub. Date: Dec. 2, 2004

(54) Method and apparatus for controlling the use of airspace and assessment of use fees and penalties

(76) Inventors: Darryl H Phillips, Sallisaw, OK (US); Philip T Hodge, Spring City, TN (US)

Correspondence Address: PITTS AND BRITTIAN P C, P O BOX 51295, KNOXVILLE, TN, 37950-1295, US

(21) Appl. No.: 10/482,746

(22) PCT Filed: Sep. 26, 2001
(86) PCT No.: PCT/US01/30129

(51) Int. Cl. G06F 17/60

(52) U.S. Cl. 705/40

(57) ABSTRACT

A method and apparatus are provided for monitoring and controlling the use of airspace over a specified area and assessing fees (24) and issuing citations related to the type of use of the controlled air space. A receiver (14) means is provided for capturing a periodic signal generated by an aircraft (16). The signal includes a unique identifying number for the aircraft (16) and the location of the aircraft. Means are provided for identifying locations within the volume of airspace above the specified area. Means are provided for comparing the location of the aircraft (16) with volume of controlled air space above the specified area. Means are provided for generating a fee assessment for billing (24) if the aircraft (16) has entered the controlled airspace. Means are provided for determining whether the aircraft (16) has violated rules or regulations applied to the controlled air space and for issuing citations for violations.

### BACKGROUND OF INVENTION

1. Field of Invention

The present invention relates generally to the field of aviation and more particularly to a method and apparatus for identifying aircraft and their locations to control the use of air space, including the assessment and collection of fees for the use or misuse of airspace.

2. Description of the Related Art

In the field of aviation, there is a tremendous interest in safety. In particular, the safety of an aircraft is enhanced substantially, when the operator of an aircraft is aware of the location and type of aircraft that are in the near vicinity. Accordingly, a system has been developed whereby each aircraft broadcasts a periodic signal that identifies (a) the aircraft by a unique identification number and (b) the precise location of the aircraft using the global positioning system (GPS). This identification system may be referred to as an automatic dependent surveillance air navigation system. Such a system is described in U.S. Pat. No. 5,570,095 issued to Drouilhet, Jr. et al on Oct. 29, 1996. Using this information, any other aircraft with a receiver can collect these broadcasts and use known algorithms to compare two sequential signals from an aircraft to determine the location, velocity and direction of travel of another aircraft. Comparing the information regarding the other aircraft with its own route and speed, mid-air accidents and near misses can be avoided because pilots are given advance warning of approaching aircraft.

Governmental units have legitimate concerns about the quality of the environments in their territories, including noise levels, air quality and safety. They seek to control the air space located above their designated territories. Frequently, governmental units seek to limit sound levels in their environments, but have difficulty identifying the source of unacceptable noise generators. For security purposes, certain areas are often restricted to prevent any flyovers, yet it is difficult to identify a particular aircraft that violates air space restrictions or even whether the aircraft has merely flown along the edges of the restricted area. Similarly, under poor climate conditions, such as low visibility, flights through a particular air space may be restricted. It is precisely the poor climate conditions that make it difficult to identify the aircraft that may be violating the restrictions.

For public safety reasons, aircraft are required to have certain preventive maintenance and documentation must be filed to verify the completion such maintenance. If the documentation has not been filed, then the aircraft is not supposed to be airborne. However, if the aircraft is operating from private airfields, for example, there may be no way of knowing whether the aircraft is violating the documentation requirements.

Governmental units seek additional sources of revenue in compensation for the use of the resources of their territories. For example, for centuries governmental units have collected tolls for the use of their roads. U.S. Pat. No. 5,424,727, issued to Shieh on Jun. 13, 1995, discloses a radio-based toll collection system in which a communication tower communicates with in-vehicle units to exchange toll collecting and payment information. Air space is a limited resource. Governmental units may decide to collect fees for the use of their respective air spaces.

### SUMMARY OF THE INVENTION

In accordance with the present invention, a method and apparatus are provided for controlling air space (the volume of air over a specified geographic area) by identifying users of the controlled air space, assessing and collecting fees related to appropriate use of the volume of air space and issuing citations for inappropriate use of the volume of air space. Generally, at least one receiver is located within the controlled air space to collect the information broadcast from each aircraft under an automatic dependent surveillance broadcast. A plurality of sound sensors may be located within the controlled air space to periodically measure sound levels at various locations within the controlled air space. A plurality of climate sensors may be located within the controlled air space to periodically collect information regarding climate conditions, including visibility, within the controlled air space. Using the information collected from the receiver, the sound sensors and the climate sensors, the route of an aircraft is compared to the volume of the controlled air space located above the specified geographic area and the period of time that the aircraft is in the air space is measured. The route is then analyzed versus any fees due for use of the controlled air space and the fees are assessed against the owner of the aircraft. The route and period of time are compared to any violations of sound limits or restricted areas. If a violation is determined to have occurred, then a citation is issued to the owner of the aircraft.

### BRIEF DESCRIPTION OF SEVERAL VIEWS OF DRAWINGS

The above-mentioned features of the invention will become more clearly understood from the following detailed description of the invention read together with the drawings in which:

FIG. 1 is a perspective view of an apparatus for controlling the use of air space.

FIG. 2 is a schematic drawing of an apparatus for controlling the use of air space.

### DETAILED DESCRIPTION OF THE INVENTION

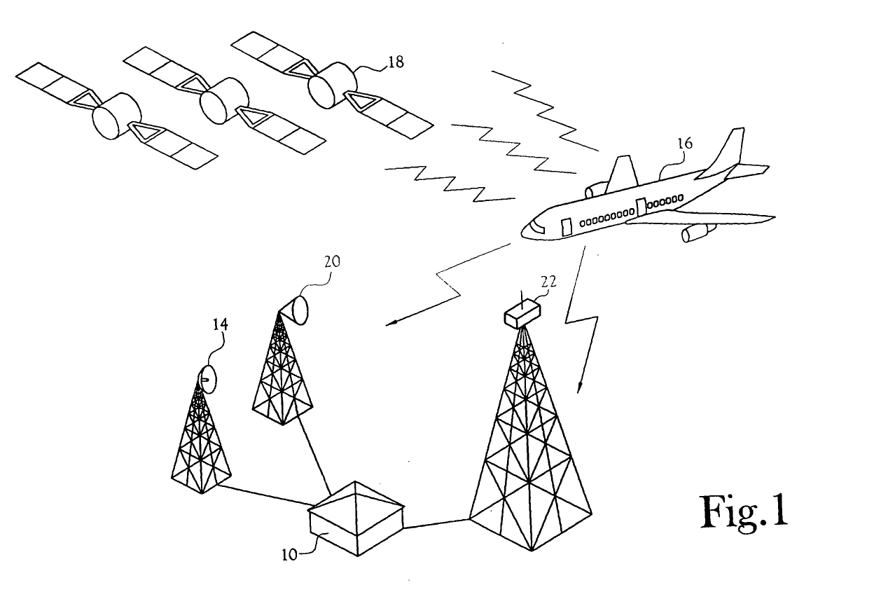

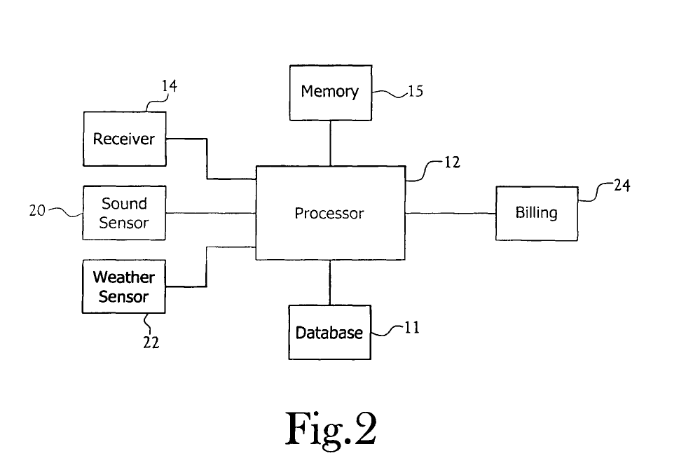

Referring now to the Figures in which like reference numerals indicate like or corresponding features, there is shown in FIGS. 1 and 2 an apparatus for controlling the use of air space. A base station 10 contains a processor 12. The processor 12 is in communication with a database 11 that identifies the volume of air space over which a user desires to maintain control and with a storage memory 15.

The processor 12 is in communication with a receiver 14. The receiver 14 is adapted to receive the periodic broadcasts from an aircraft 16 identifying the aircraft 16 by a unique identification number and the precise location of the aircraft 16. The precise position of an aircraft 16 in flight is determined through use of global positioning system satellites 18.

The processor 12 is in communication with a sound sensor 20, which is located in an area having limitations on acceptable noise levels. As desired multiple sound sensors 20 may be located within the volume of the air space under control.

The processor 12 is in communication with a climate sensor 22, which is adapted to measure one or more climate conditions, such as visibility or precipitation, for example. As desired, multiple climate sensors 22 may be located within the volume of the air space under control.

The processor 12 is in communication with a billing system 24 adapted to generate a bill for fees and/or charges calculated by the processor 12.

Those skilled in the art will recognize that a variety of communication mechanisms, for example direct wiring, radio frequency (RF), microwave or other common types, can be used to transmit information between the various components of the system.

In operation, when the receiver 14 receives a broadcast signal from an aircraft 16, the information in the signal, i.e., the identification number and GPS location, is communicated to the processor 12. The processor 12 compares the location of the aircraft 16 with the database of the volume of the controlled air space to determine whether the aircraft is within the controlled air space. If the location of the aircraft 16 is not within the controlled volume of air space, the signal is ignored. If the location of the aircraft 16 is within the controlled volume of air space, the location, time and identification number of the aircraft 16 is stored in the memory unit 15. By correlating the time and position information associated with a particular aircraft identification number, the entire route that the aircraft 16 travels within the controlled air space is reconstructed. In addition, the times that the aircraft 16 enters and leaves the controlled airspace may be used to calculate the duration of time that the aircraft 16 was located within the controlled air space.

If the entity controlling the air space has authorization to assess fees for the use of the controlled air space, either based upon mere entry, distance traveled or duration of travel or some other basis, the processor calculates the fee using the stored information about the route of the aircraft 16 and known algorithms. The identity of the owner associated with the unique identification number of the aircraft 16 may be stored in the database 11 and used for billing purposes.

The sound sensor 20 measures the sound level within the controlled air space either periodically or continuously. The measurement of sound level is communicated from the sound sensor 20 to the processor 12. The processor compares the sound level to a database identifying volumes within the controlled air space for which acceptable sound levels have been set. If the measured sound level is less than the acceptable level for the location of the sound sensor 20, then the signal is ignored. If the sound level measurement exceeds the acceptable level for the location of the sound sensor 20, then the sound level measurement is stored in the memory 15, along with the location of the sound sensor 20 and the time of the sound level measurement. Each time a sound level measurement is received, the sound level measurement is similarly compared and stored, if it exceeds the acceptable level. Employing multiple sound sensors located throughout the controlled air space, an excess sound route is generated. The processor compares the excess sound route to the route traveled by the aircraft 16 as it travels within the controlled air space. If the excess sound route coincides with the aircraft route at the same time, then a citation may be issued to the aircraft owner through the billing system 24.

The climate sensor 22 measures a feature of the climate within the controlled air space, such as visibility or precipitation, for example, either periodically or continuously. The climate measurement is communicated from the climate sensor 22 to the processor 12. The processor 12 compares the climate measurement to a database identifying volumes within the controlled air space for which acceptable climate measurement ranges have been set. If the climate measurement is within the acceptable range for the location of the climate sensor 22, then the signal is ignored. If climate measurement is outside the acceptable range for the location of the climate sensor 22, then the climate measurement is stored, along with the location of the climate sensor 22 and the time of the climate measurement. Each time a climate measurement is received, the climate measurement is similarly compared and stored, if appropriate. By employing multiple climate sensors located throughout the controlled air space, the boundaries of a no-fly zone is generated. These boundaries may be communicated to the aircraft by radio, for example. The processor compares the no-fly zone to the route traveled by the aircraft 16 as it travels within the controlled air space. If the aircraft route crosses into a no-fly zone during the time that the no-fly zone is in effect, then a citation may be issued through the billing system 24.

It will be recognized that the climate information and sound level information may be stored in the memory 15 and used at a later time to generate an excess sound map and a climate map which may be compared to the reconstructed routes of aircraft that have entered the controlled airspace.

It will be recognized by one skilled in the art that varying types of fees may be assessed and citations issued for violation of rules and regulations applied to the controlled air space. For example, if regulations in effect require the filing of documents before the aircraft is allowed to enter the airspace, a citation may be generated immediately upon recognition that a violator has entered the air space.

While a preferred embodiment has been shown and described, it will be understood that it is not intended to limit the disclosure, but rather is intended to cover all modifications and alternate methods and apparatus within the spirit and scope of the invention.

We claim:

1. A data processing system for controlling the use of an air space over a specified area and assessing fees related to the type of use of said controlled air space comprising:
(a) receiver means for capturing a periodic signal generated by an aircraft, said signal including a unique identifying number for said aircraft and the location of said aircraft,
(b) means for identifying locations within said controlled air space above said specified area,
(c) means for comparing said location of said aircraft with said locations within said controlled air space, and
(d) means for generating a fee assessment if said aircraft has entered said controlled airspace.

2. An apparatus in accordance with claim 1 wherein said means for generating a fee assessment includes means for determining the distance traveled by said aircraft within said controlled air space.

3. An apparatus in accordance with claim 2 wherein said means for generating a fee assessment includes means for determining the length of time during which said aircraft was located within said controlled air space.

4. An apparatus in accordance with claim 1 and further comprising sound sensor means for measuring the noise level at multiple locations within said controlled airspace.

5. An apparatus in accordance with claim 4 wherein said means for generating a fee assessment includes means for determining whether noise levels sensed by said sound sensor means exceed a predetermined acceptable level and coincide with a route of said aircraft.

6. An apparatus in accordance with claim 1 and further comprising climate sensor means for defining a no-fly area.

7. A method for controlling the use of an airspace over a specified area and assessing fees related to the use of said controlled air space comprising:
(a) capturing a signal generated by an aircraft, said signal including a unique number identifying said aircraft and the location of said aircraft,
(b) comparing said location of said aircraft to said controlled airspace, and
(c) assessing a fee if said aircraft has entered said controlled air space.

8. A method in accordance with claim 7 and further comprising:
(d) calculating the distance trammeled by said aircraft within said controlled air space and calculating a fee assessment based upon said distance traveled by said aircraft within said controlled air space.

9. A method in accordance with claim 7 and further comprising:
(e) calculating the period of time during which said aircraft is located within said volume of said airspace above said specified area and calculating said fee assessment based upon said period of time during which said aircraft is located within said controlled airspace.

10. A method in accordance with claim 7 and further comprising:
(f) measuring sound levels in multiple locations within said controlled air space above said specified area,
(g) determining whether said sound levels exceed predetermined acceptable levels,
(h) comparing the locations of sound levels that exceed said predetermined acceptable levels with said location of said aircraft, and
(i) calculating said fee assessment based upon said excess of predetermined acceptable sound levels.

11. A method in accordance with claim 7 and further comprising:
(j) measuring a climate condition at within said controlled airspace,
(k) comparing said measurement of said climate condition to an acceptable climate condition level to permit flight, and
(l) calculating said fee assessment based upon use of said controlled air space during unacceptable climate conditions.

12. A method in accordance with claim 7 and further comprising:
(m) calculating said fee based upon a failure to file proper documentation related to said aircraft.
